(19) United States
(12) Patent Application Publication
(10) Pub. No.: US 2024/0370279 A1
(43) Pub. Date: Nov. 7, 2024

(54) Head-Mounted Device with Shortcuts

(71) Applicant: Apple Inc., Cupertino, CA (US)

(72) Inventors: Ashwin K. Vijay, Sunnyvale, CA (US); Paul Ewers, San Jose, CA (US)

(21) Appl. No.: 18/646,086

(22) Filed: Apr. 25, 2024

Related U.S. Application Data
(60) Provisional application No. 63/500,488, filed on May 5, 2023.

(51) Int. Cl. G06F 9/451; G02B 27/01; G06F 3/01; G06F 3/0484

(52) U.S. Cl. CPC G06F 9/451; G02B 27/017; G06F 3/013; G06F 3/0484

(57) ABSTRACT

An electronic device may include one or more sensors that gather sensor data. The sensors may include cameras that capture images. The electronic device may determine contextual information based on the captured images and/or other sensor data. The determined contextual information may be compared to the contextual triggers of shortcuts in a shortcut database. In response to identifying a match between the determined contextual information and a shortcut in the shortcut database, the head-mounted device may present a suggestion associated with the shortcut. Based on user input, the head-mounted device may perform one or more actions associated with the shortcut and/or automatically perform the actions associated with the shortcut during subsequent identifications of the contextual trigger.

This application claims the benefit of U.S. provisional patent application No. 63/500,488 filed May 5, 2023, which is hereby incorporated by reference herein in its entirety.

### BACKGROUND

This relates generally to electronic devices, and, more particularly, to head-mounted devices with one or more output devices. Some head-mounted devices may use one or more output devices to provide output. The head-mounted device may provide output in response to user input.

It is within this context that the embodiments herein arise.

### SUMMARY

An electronic device comprising one or more sensors, one or more processors, and memory storing instructions configured to be executed by the one or more processors, the instructions for: obtaining, via a first subset of the one or more sensors, first sensor data, determining contextual information based on the first sensor data, comparing the determined contextual information to a database of shortcuts, and in response to identifying a match between the determined contextual information and a contextual trigger for a given shortcut in the database, presenting a suggestion associated with the given shortcut. The first sensor data may include one or more images and each shortcut in the database may include an associated contextual trigger.

### BRIEF DESCRIPTION OF THE DRAWINGS

FIG. 1 is a schematic diagram of an illustrative electronic device in accordance with some embodiments.

FIG. 2 is a schematic diagram of an illustrative external server with a shortcut database in accordance with some embodiments.

FIG. 3 is a flowchart of an illustrative method for suggesting a shortcut from a shortcut database using contextual information in accordance with some embodiments.

FIG. 4 is a flowchart of an illustrative method for generating a shortcut based on contextual information in a local history in accordance with some embodiments.

FIG. 5 is a diagram showing how a shortcut database may both receive shortcuts from users and provide shortcuts to users in accordance with some embodiments.

### DETAILED DESCRIPTION

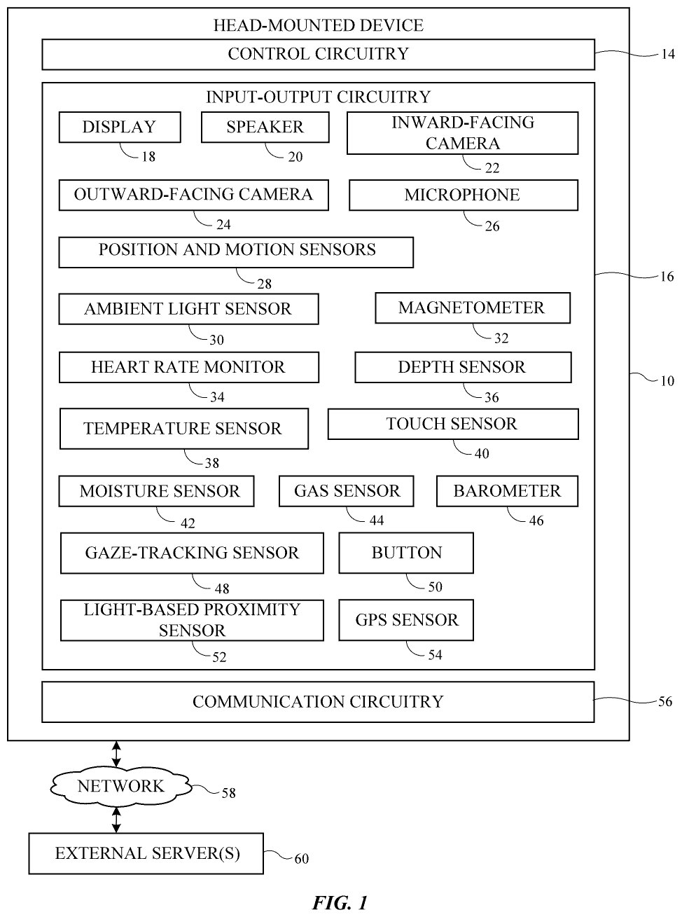

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Camera images (e.g., from one of cameras 22) may also be used for monocular and/or stereo depth estimation. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with one or more external servers 60 through network(s) 58. Examples of communication network(s) 58 include local area networks (LAN) and wide area networks (WAN) (e.g., the Internet). Communication network(s) 58 may be implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

External server(s) 60 may be implemented on one or more standalone data processing apparatus or a distributed network of computers. External server 60 may provide information such as shortcut information to head-mounted device 10 (via network 58) in response to information from head-mounted device 10.

Head-mounted device 10 may communicate with external server(s) 60 to obtain information on one or more shortcuts. Each shortcut may have an associated contextual trigger and one or more actions associated with the shortcut. Head-mounted device 10 may receive information regarding the shortcuts from external server(s) 60 and store the received information for subsequent use. Instead or in addition, head-mounted device 10 may send contextual information to external server(s) 60 and external server(s) 60 may identify one or more matches between the received contextual information and a contextual trigger for a shortcut.

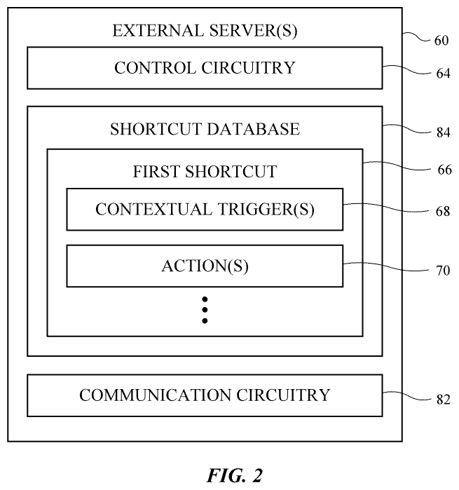

A schematic diagram of an illustrative external server 60 is shown in FIG. 2. As shown in FIG. 2, external server(s) 60 may have control circuitry 64. Control circuitry 64 may be configured to perform operations using hardware (e.g., dedicated hardware or circuitry), firmware and/or software. Software code for performing operations in external server(s) 60 and other data is stored on non-transitory computer readable storage media (e.g., tangible computer readable storage media) in control circuitry 64. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 64. The processing circuitry may include application-specific integrated circuits with processing circuitry, one or more microprocessors, digital signal processors, graphics processing units, a central processing unit (CPU) or other processing circuitry.

External server(s) 60 also include communication circuitry 82. Communication circuitry 82 in FIG. 2 may have the same functionality as communication circuitry 56 in FIG. 1 and the descriptions of communication circuitry 56 therefore fully apply to communication circuitry 82. For simplicity the description of circuitry 82 will not be duplicated herein in connection with FIG. 2. External server(s) 60 may use communication circuitry 82 to communicate with head-mounted device 10 through network 58.

As shown in FIG. 2, external server(s) 60 may include a shortcut database 84 (e.g., stored in memory of control circuitry 64). The shortcut database may include information for a plurality of shortcuts. FIG. 2 shows a first shortcut 66. In general, the shortcut database 84 may include information for any desired number (n) of shortcuts.

Control circuitry 64 may store various types of information for each shortcut. In the example of FIG. 2, the information stored for each shortcut includes contextual trigger(s) 68 and action(s) 70. Additional types of information may also be included for each shortcut if desired.

Contextual trigger(s) 68 may list one or more contextual triggers that are used to trigger the action(s) 70 associated with shortcut 66. The contextual trigger may include, as examples, a location, an activity, an identity of a physical object in a physical environment, information from an application, information from a paired external electronic device, and/or any other desired information.

A location that serves as at least part of a contextual trigger may be a specific location (e.g., based on GPS coordinates) or a general location out of multiple categories. The general locations may include home (e.g., the home of the user of the head-mounted device), workplace (e.g., an office or other place-of-focus for the user of the head-mounted device), public indoor space (e.g., stores, restaurants, etc.), transit location (e.g., in a car, train, plane, bus, etc.), outdoor space, etc.

An activity that serves as at least part of a contextual trigger may be a specific activity (e.g., rock climbing, playing piano, etc.) or a general activity out of multiple categories. The general activities may include donning the electronic device, doffing the electronic device, watching media, focusing, socializing, exercising, driving, eating, etc.

The identity of a physical object in a physical environment around the head-mounted device 10 may serve as at least part of a contextual trigger. For example, a rock climbing wall detected in the physical environment may serve as a contextual trigger for an action associated with rock climbing. A piano detected in the physical environment may serve as a contextual trigger for an action associated with playing piano.

In general, any information from or regarding a display, speaker, inward-facing camera, outward-facing camera, microphone, position and motion sensor, ambient light sensor, magnetometer, heart rate monitor, depth sensor, temperature sensor, touch sensor, moisture sensor, gas sensor, barometer, gaze-tracking sensor, button, light-based proximity sensor, and/or GPS sensor may be used as a contextual trigger 68 for a shortcut.

For example, a display such as display 18 being turned or presenting a particular type of content may be used as a contextual trigger for a shortcut. A speaker such as speaker 20 being turned or presenting a particular type of content may be used as a contextual trigger for a shortcut. Information (e.g., images and/or information derived from the images such as the identities of physical objects) from an inward-facing camera such as inward-facing camera 22 may be used as a contextual trigger for a shortcut. Information (e.g., images and/or information derived from the images such as the identities of physical objects) from an outward-facing camera such as outward-facing camera 24 may be used as a contextual trigger for a shortcut. Audio detected by a microphone such as microphone 26 (e.g., a particular voice, music, etc.) may be used as a contextual trigger for a shortcut. Position and/or motion data from position and motion sensors such as position and motion sensors 28 (e.g., data identifying a head gesture) may be used as a contextual trigger for a shortcut. Sensor data from an ambient light sensor such as ambient light sensor 30 may be used as a contextual trigger for a shortcut. Sensor data from a magnetometer such as magnetometer 32 may be used as a contextual trigger for a shortcut. Sensor data from a heart rate monitor such as heart rate monitor 34 (e.g., data indicating a high heart rate associated with exercise) may be used as a contextual trigger for a shortcut. Depth information from a depth sensor such as depth sensor 36 may be used as a contextual trigger for a shortcut. Sensor data from a temperature sensor such as temperature sensor 38 may be used as a contextual trigger for a shortcut. Sensor data from a touch sensor such as touch sensor 40 may be used as a contextual trigger for a shortcut. Sensor data from a moisture sensor such as moisture sensor 42 may be used as a contextual trigger for a shortcut. Sensor data from a gas sensor such as gas sensor 44 may be used as a contextual trigger for a shortcut. Sensor data from a barometer sensor such as barometer sensor 46 may be used as a contextual trigger for a shortcut. Gaze detection data from a gaze-tracking sensor such as gaze-tracking sensor 48 may be used as a contextual trigger for a shortcut. Button press data from a button such as button 50 may be used as a contextual trigger for a shortcut. Sensor data from a light-based proximity sensor such as light-based proximity sensor 52 may be used as a contextual trigger for a shortcut. Location data from a GPS sensor such as GPS sensor 54 may be used as a contextual trigger for a shortcut.

Contextual triggers 68 may include information regarding one or more applications running and/or installed on head-mounted device 10 (e.g., the number of applications installed, the type of applications installed, the number of applications running, the type of applications running, and/or data from the applications currently running).

Contextual triggers 68 may include information received from one or more additional electronic devices such as an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

There may be a variety of actions 70 associated with a given shortcut 66 in the shortcut database 84. Actions 70 may include presenting content (e.g., using a display and/or a speaker) or providing other output (e.g., haptic output) using an electronic device such as head-mounted device 10. Instead or in addition, actions 70 may include opening an application or providing an instruction to an application running on an electronic device such as head-mounted device 10. Instead or in addition, actions 70 may include transmitting a command to one or more additional electronic devices.

Consider the example of a shortcut associated with a user playing piano. The contextual triggers 68 may include a detected location close to a known location of a piano, an identification of a piano in the user's physical environment (e.g., using camera images), a microphone detecting sound associated with the piano, etc. Actions 70 may include opening an application associated with a piano tutorial, displaying a video with a piano lesson, transmitting a command to one or more lights in the physical environment to achieve a target lighting, etc.

During operation, head-mounted device 10 may transmit a shortcut request to external server(s) 60 with contextual information. External server(s) 60 may receive the contextual information from head-mounted device 10 and (e.g., using control circuitry 64) identify one or more shortcuts in the shortcut database 84 that matches the received contextual information. After identifying the matching shortcut(s), external server(s) 60 may transmit information associated with the matching shortcut(s) such as action(s) 70 to head-mounted device 10.

If desired, shortcut database 84 may instead be stored on head-mounted device 10 (e.g., in control circuitry 14) instead of in external server(s) 60. In this case, head-mounted device 10 may determine contextual information and identify one or more shortcuts in the shortcut database 84 that matches the received contextual information.

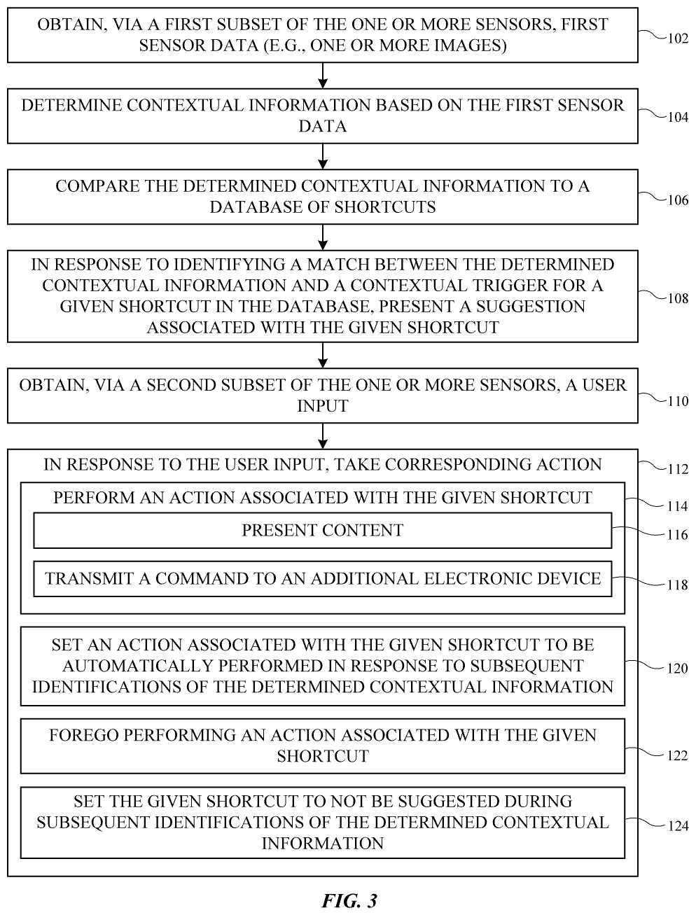

FIG. 3 is a flowchart showing an illustrative method for operating an electronic device that uses shortcut suggestions. At block 102, an electronic device such as head-mounted device 10 may obtain, via a first subset of the one or more sensors in the device, first sensor data. The first sensor data may include sensor data from one or more sensors such as inward-facing camera 22, outward-facing camera 24, microphone 26, position and motion sensors 28, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, and/or GPS sensor 54. The first sensor data may include one or more images from outward-facing camera 24 as an example.

Next, at block 104, head-mounted device 10 (e.g., control circuitry 14) may determine contextual information based on at least the first sensor data. The determined contextual information may include a location, an activity, an identity of a physical object in a physical environment, and/or any other desired information.

The location included in the determined contextual information may include a specific location (e.g., based on GPS coordinates) and/or or a general location out of multiple categories (e.g., home, workplace, public indoor space, transit location, outdoor space, etc.).

The activity included in the determined contextual information may include a specific activity or a general activity out of multiple categories (e.g., donning the electronic device, doffing the electronic device, watching media, focusing, socializing, exercising, driving, eating, etc.).

At block 104, the identity of a physical object in a physical environment may be determined using the one or more images from an outward-facing camera (obtained at block 102). This example is merely illustrative and the identity of the physical object in the physical environment may be determined using any other desired sensor data from block 104 if desired.

Instead or in addition, contextual information determined at block 104 may include information regarding one or more output devices. For example, the contextual information may include whether or not display 18 is turned and/or the type of visual content being displayed on display 18. The contextual information may include whether or not speaker 20 is turned and/or the type of audio content being presented using speaker 20.

Instead or in addition, contextual information determined at block 104 may include information regarding one or more applications running and/or installed on head-mounted device 10 (e.g., the number of applications installed, the type of applications installed, the number of applications running, the type of applications running, and/or data from the applications currently running).

Instead or in addition, contextual information determined at block 104 may include information received from one or more additional electronic devices. The additional electronic device that provides contextual information may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

At block 106, the determined contextual information may be compared to a database of shortcuts. The database of shortcuts may be stored locally on head-mounted device 10 or may be stored on external server(s) 60 and accessed using wireless communication. When the database is stored on external server(s) 60, head-mounted device 10 may transmit the determined contextual information to external server(s) 60 at block 106 (e.g., using communication circuitry 56).

In general, users may manually generate shortcuts or shortcuts may be generated by a head-mounted device in response to the head-mounted device recognizing a pattern in the user's contextual triggers and corresponding actions.

The database of shortcuts may include shortcuts created by users of other electronic devices (e.g., head-mounted devices). When any user generates a shortcut, that user may choose to add the shortcut to the shortcut database. While in the shortcut database, the shortcut may be compared to a given user's contextual information to identify if the shortcut may be relevant to the given user. The given user may then choose to add the shortcut to their particular head-mounted device.

As previously discussed, each shortcut in the shortcut database may include one or more contextual triggers 68 and one or more actions 70. Comparing the determined contextual information to the database of shortcuts during the operations of block 106 may include comparing the determined contextual information to the contextual trigger(s) of each shortcut.

The operations of blocks 102-106 may be performed in response to user input (e.g., a user request to identify potentially relevant shortcuts) and/or in response to head-mounted device 10 detecting a repeated pattern in device behavior. As another example, the operations of blocks 102-106 may be performed at some predetermined interval. For example, once a week (or at some other desired interval) the head-mounted device 10 may compare contextual information for the head-mounted device to the shortcut database to see if any shortcuts in the database may be relevant to the head-mounted device.

During the operations of bock 108, head-mounted device 10 may, in response to identifying a match between the determined contextual information and a contextual trigger for a given shortcut in the database, present a suggestion associated with the given shortcut. Identifying the match may include identifying some or all of the components of the determined contextual information in the contextual trigger for the given shortcut.

The match may be an exact match or a partial match (in either direction). For example, the determined contextual information may include components a, b, and c. A first shortcut may have a contextual trigger with components a, b, and c. This is an exact match and may be considered a match at blocks 106 and/or 108. A second shortcut may have a contextual trigger with components a, b, c, and d (e.g., all of the components of the determined contextual information plus at least one additional component). This may or may not be considered a match at blocks 106 and/or 108 (e.g., depending on user preferences). A third shortcut may have a contextual trigger with components a and b (e.g., some but not all of the components of the determined contextual information). This may or may not be considered a match at blocks 106 and/or 108 (e.g., depending on user preferences).

When the database is stored on external server(s) 60, head-mounted device 10 may receive information regarding the matching shortcut from the external server(s) 60 at block 108 (e.g., using communication circuitry 56).

Presenting the suggestion associated with the given shortcut may include presenting a suggestion to the user to perform the action(s) associated with the shortcut once (e.g., a single-use of the shortcut). Instead or in addition, presenting the suggestion associated with the given shortcut may include presenting a suggestion to the user to automatically perform the shortcut in response to subsequent identifications of the determined contextual information (e.g., automatic use of the shortcut).

Presenting the suggestion at block 108 may include presenting the suggestion visually using display 18 (e.g., by displaying text or an icon) and/or presenting the suggestion audibly using speaker 20 (e.g., using a chime or voice prompt).

Presenting the suggestion at block 108 may also include presenting response options such as “Yes, perform the shortcut once,” “Yes, perform the shortcut automatically,” “No, do not perform the shortcut this time,” and “Never perform the shortcut.”

During the operations of block 110, the head-mounted device 10 may obtain, via a second subset of the one or more sensors, a user input. The user input may be a voice command or other input that is detected using microphone 26, a touch input or other input that is detected using touch sensor 40, gaze input or other input that is detected using gaze-tracking sensor 48, a head gesture or other input that is detected using position and motion sensors 28, a hand gesture or other input that is detected using cameras 22 and/or 24, a button press or other input that is detected using button 50, and/or other desired user input.

In response to the user input received at block 110, the head-mounted device may take corresponding action at block 112.

The operations of block 112 may include performing an action associated with the given shortcut as in block 114. Performing the action (e.g., action 70 for shortcut 66) in block 114 may include presenting content as in block 116. Presenting content as in block 116 may include presenting content using display 18 and/or speaker 20. The presented content may include pictures, videos, songs, sound effects, content associated with an application, etc.

Performing the action (e.g., action 70 for a shortcut 66) in block 114 may include transmitting a command to an additional electronic device as in block 118. The command may be transmitted wirelessly using communication circuitry 56. The additional electronic device may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

The command transmitted at block 118 may be a command to change an output device associated with the additional electronic device. For example, head-mounted device 10 may command a speaker to play music at block 118, may command a light to reduce its brightness at block 118, may command a television to turn on its display at block 118, etc.

The operations of block 112 may include setting an action associated with the given shortcut to be automatically performed in response to subsequent identifications of the determined contextual information as in block 120. In other words, the user input may indicate that the user wishes the shortcut to automatically be performed when the contextual trigger is present (without soliciting a user input). This example is merely illustrative. The user may instead select to be prompted to perform the action associated with the given shortcut in response to subsequent identifications of the determined contextual information.

The operations of block 112 may include foregoing performing an action associated with the given shortcut as in block 122. In other words, the user may decline following through with the action(s) of the suggested shortcut.

The operations of block 112 may include setting the given shortcut to not be suggested during subsequent identification of the determined contextual information as in block 124. In other words, instead of or in addition to declining the shortcut, the user may provide user input indicating that they do not wish the shortcut to be suggested again (even if the determined contextual information is identified again).

As an example, consider an example of a user that frequently uses a home gym with one or more pieces of exercise equipment. Head-mounted device 10 may obtain first sensor data at block 102 using one or more of inward-facing camera 22, outward-facing camera 24, microphone 26, position and motion sensors 28, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, and GPS sensor 54. The first sensor data may include one or more images (e.g., from outward-facing camera 24).

At block 104, the head-mounted device may determine contextual information based on the first sensor data. The determined contextual information may include information such as location information (e.g., home, home gym, indoor location, etc.) and activity information (e.g., exercising, weightlifting, stationary bike riding, etc.). The determined contextual information may include the identity of one or more physical objects in the physical environment of head-mounted device 10 (e.g., an adjustable weight bench, a stationary bike, etc.). The determined contextual information may include information from one or more additional electronic devices (e.g., a paired watch that is running a workout application).

At block 106, head-mounted device 10 may compare the determined contextual information to a database of shortcuts. The head-mounted device may compare the determined contextual information to a shortcut database in memory of the head-mounted device. Instead or in addition, the head-mounted device may wirelessly communicate with an external server to compare the determined contextual information to a shortcut database stored in memory of the external server.

At block 108, in response to identifying a match between the determined contextual information and a contextual trigger for a given shortcut in the database, head-mounted device 10 may present a suggestion associated with a given shortcut. As a specific example, the shortcut database may include a given shortcut 66 with contextual triggers 68 of a user being in a home gym, a stationary bike being identified in the user's physical environment, and a user running a workout application on a paired watch. In this example, the contextual information determined at block 104 also includes the user being in a home gym, a stationary bike being identified in the user's physical environment, and a user running a workout application on a paired watch. Therefore the given shortcut 66 is a match to the contextual information determined at block 104.

The suggestion associated with the given shortcut may include a displayed prompt to perform the action(s) associated with the given shortcut. Text such as “Would you like to perform a stationary bike shortcut?” or similar text may be displayed on display 18. Response options such as “Yes,” “Yes, every time,” “No,” and/or “Never,” may also be displayed. Alternatively, an audio prompt with the suggestion and/or response options may be presented using speaker 20.

At block 110, the user may provide user input to the head-mounted device 10 by providing a voice command to microphone 26. In response, head-mounted device 10 takes corresponding action at block 112.

In one scenario, the user may accept the shortcut suggested at block 108. In this case, head-mounted device may perform action(s) 70 associated with the given shortcut (as in block 114). In this case, action(s) 70 including opening a biking application on the head-mounted device 10, displaying a user heart rate using display 18, commanding a smart speaker in the home gym to play music, and commanding a light in the home gym to turn to full brightness.

If the user accepts the shortcut suggested at block 108, an additional prompt may be presented regarding the shortcut being automatically be performed in response to subsequent identifications of the determined contextual information. The additional prompt may instead be presented simultaneously with the suggestion at block 108. As yet another option, the option of automatically performing the shortcut may be incorporated into the initial response options of block 108.

In one scenario, the user may request that the actions 70 associated with shortcut 66 are automatically performed in response to subsequent identifications of the determined contextual information (as in block 120). In this example, the actions of opening the biking application on the head-mounted device 10, displaying the user heart rate using display 18, commanding the smart speaker in the home gym to play music, and commanding the light in the home gym to turn to full brightness may be automatically performed whenever the contextual triggers (the user being in the home gym, the stationary bike being identified in the user's physical environment, and the user running the workout application on the paired watch) are detected.

In another scenario the user may decline the shortcut suggested at block 108. In this case, head-mounted device 10 may forego performing action(s) 70 associated with the given shortcut (as in block 122).

If the user declines the shortcut suggested at block 108, an additional prompt may be presented regarding the shortcut being no longer suggested in response to subsequent identifications of the determined contextual information. The additional prompt may instead be presented simultaneously with the suggestion at block 108. As yet another option, the option of no longer suggesting the shortcut may be incorporated into the initial response options of block 108.

The user may request that the given shortcut 66 is no longer suggested (even during identifications of the determined contextual information) as in block 124.

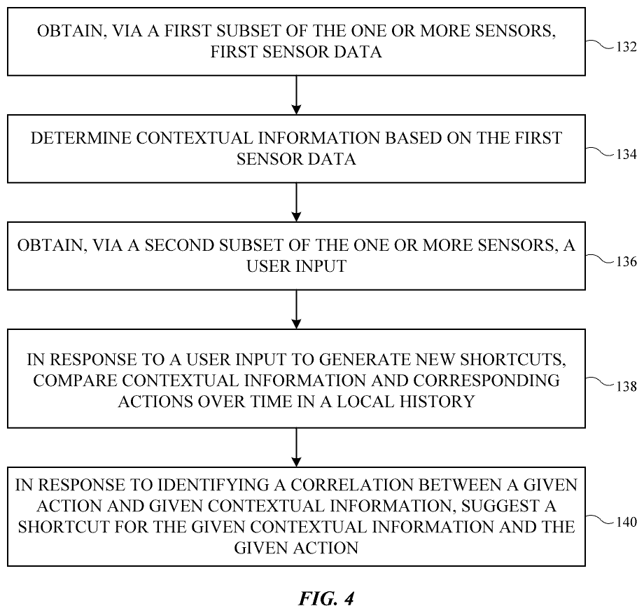

FIG. 4 is a flowchart showing an illustrative method for operating an electronic device when a user requests generation of new shortcuts. At block 132, an electronic device such as head-mounted device 10 may obtain, via a first subset of the one or more sensors in the device, first sensor data. The first sensor data may include sensor data from one or more sensors such as inward-facing camera 22, outward-facing camera 24, microphone 26, position and motion sensors 28, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, and/or GPS sensor 54. The first sensor data may include one or more images from outward-facing camera 24 as an example.

At block 134, head-mounted device 10 may determine contextual information based on the sensor data. The descriptions in connection with block 104 of FIG. 3 also apply to block 134 in FIG. 4 and will not be repeated for brevity.

During the operations of block 136, the head-mounted device 10 may obtain, via a second subset of the one or more sensors, a user input. The user input may include a voice command or other input that is detected using microphone 26, a touch input or other input that is detected using touch sensor 40, gaze input or other input that is detected using gaze-tracking sensor 48, a head gesture or other input that is detected using position and motion sensors 28, a hand gesture or other input that is detected using cameras 22 and/or 24, a button press or other input that is detected using button 50, and/or other desired user input.

The user input at block 136 may indicate a request from the user to identify possible new shortcuts. At block 138, in response to the user input to generate new shortcuts, the head-mounted device may compare contextual information and corresponding actions over time in a local history.

Head-mounted device 10 may store contextual information and other device actions over time in a local history. During block 138, the local history may be analyzed to identify patterns. For example, a user may consistently play music using a smart speaker when they start using a stationary bike in their home gym. This is an example of a pattern with contextual information (e.g., the location of a home gym and the identification of a stationary bike using camera images) and a corresponding action (playing music using a smart speaker).

The local history for any desired period may be analyzed (e.g., at least one day, at least one week, at least one month, etc.). If desired, the user input at block 136 may indicate a piece of contextual information that the user desires to be part of the new shortcut. For example, the user may request new shortcuts related to the use of their home gym. In this case, head-mounted device 10 may compare contextual information including the location of the home gym at block 138.

At block 140, in response to identifying a correlation between a given action and given contextual information, the head-mounted device may suggest a shortcut for the given contextual information and the given action. The suggestion may be presented using display 18 and/or speaker 20.

Continuing the previous example, at block 140 the head-mounted device 10 may present a suggestion for a shortcut to automatically turn on music when the user is using a stationary bike in their home gym. The user may provide further user input to optionally add this shortcut to a list of shortcuts that are automatically performed.

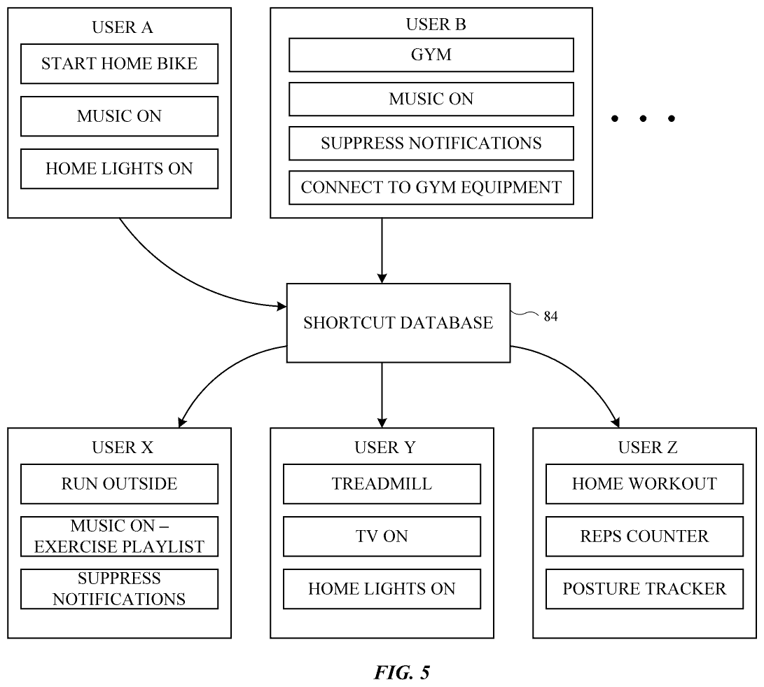

FIG. 5 is a diagram illustrating how a shortcut database may both receive shortcuts from users and suggest shortcuts to users. FIG. 5 shows an example where user A has established a shortcut that involves turning on music and lights in response to the user starting a home bike (e.g., starting to use a stationary bike for a workout session). This shortcut information may be provided to shortcut database 84. Also in FIG. 5, user B has established a shortcut that involves turning on music, suppressing notifications, and connecting to gym equipment lights in response to the user entering a gym. This shortcut information may be provided to shortcut database 84.

Shortcut database 84 may receive shortcuts from at least tens of users, at least hundreds of users, at least thousands of users, etc. Common concepts and contexts may be extracted from the database of shortcuts (e.g., by control circuitry 64 in one or more external server(s) 60, by control circuitry 14 in a head-mounted device or other type of electronic device, etc.). For example, the shortcuts in the shortcut database may indicate that users tend to turn on music or other media when they start exercising. The shortcuts in the shortcut database may indicate different tendencies in different locations (e.g., home gym, outside, external gym, etc.), at different times of day, for different types of exercise, etc.

The information extracted from shortcut database 84 may be used to suggest shortcuts for other users. The other users (e.g., users X, Y, and Z in FIG. 5) may receive shortcut suggestions based on user input (e.g., the user may request generation of new shortcuts as in step 138 of FIG. 4). Instead or in addition, the other users may receive shortcut suggestions based on a detected overlap between the user's activities and one or more shortcuts in database 84.

FIG. 5 shows a user X who receives a shortcut suggestion to turn on music and suppress notifications when it is detected that the user is running outside. The suggested shortcut may be tailored to user X based on information regarding user X's tendencies. For example, user X may have an exercise playlist that they listen to when exercising. This exercise playlist may therefore be used in the suggested shortcut for user X. FIG. 5 also shows user Y who receives a shortcut suggestion to turn on a television and lights when it is detected that the user is using a treadmill. The suggested shortcut may be tailored to user Y based on information regarding user Y's tendencies. For example, user Y may tend to watch television when exercising. Therefore, the shortcut suggestion for user Y is for the user to watch television (instead of turning on music as with user X). FIG. 5 also shows user Z who receives a shortcut suggestion to turn on a reps counting application and a posture tracker application (e.g., applications on a head-mounted device) when it is detected that the user is starting a home workout. The suggested shortcut may be tailored to user Z based on information regarding user Z's tendencies. For example, user Z may tend to use the reps counting application and posture tracking application when exercising at home.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more sensors;
one or more processors; and
memory storing instructions configured to be executed by the one or more processors, the instructions for:
obtaining, via a first subset of the one or more sensors, first sensor data, wherein the first sensor data comprises one or more images;
determining contextual information based on the first sensor data;
comparing the determined contextual information to a database of shortcuts, wherein each shortcut comprises an associated contextual trigger; and
in response to identifying a match between the determined contextual information and a contextual trigger for a given shortcut in the database, presenting a suggestion associated with the given shortcut.

2. The electronic device defined in claim 1, wherein the instructions further comprise instructions for:
obtaining, via a second subset of the one or more sensors, a user input; and
in response to the user input, performing an action associated with the given shortcut, wherein performing the action associated with the given shortcut comprises presenting content or transmitting a command to an additional electronic device.

3. The electronic device defined in claim 2, wherein the instructions further comprise instructions for:
in response to the user input, setting an action associated with the given shortcut to be automatically performed in response to subsequent identifications of the determined contextual information.

4. The electronic device defined in claim 1, wherein the instructions further comprise instructions for:
obtaining, via a second subset of the one or more sensors, a user input;
in response to the user input, foregoing performing an action associated with the given shortcut; and
in response to the user input, setting the given shortcut to not be suggested during subsequent identifications of the determined contextual information.

5. The electronic device defined in claim 1, wherein the database of shortcuts is stored in at least one external server and wherein comparing the determined contextual information to a database of shortcuts comprises transmitting the determined contextual information to the at least one external server.

6. The electronic device defined in claim 1, wherein the database of shortcuts comprises shortcuts generated using additional electronic devices.

7. The electronic device defined in claim 1, wherein the determined contextual information comprises an identity of a physical object in a physical environment of the electronic device, a location, or an activity.

8. The electronic device defined in claim 1, wherein the first subset of the one or more sensors comprises a camera, an accelerometer, a depth sensor, a microphone, an ambient light sensor, a magnetometer, a heart rate monitor, a temperature sensor, a touch sensor, a moisture sensor, a gas sensor, a barometer, a gaze-tracking sensor, a button, a light-based proximity sensor, or a global positioning system (GPS) sensor.

9. A method of operating an electronic device that comprises one or more sensors, the method comprising:
obtaining, via a first subset of the one or more sensors, first sensor data, wherein the first sensor data comprises one or more images;
determining contextual information based on the first sensor data;
comparing the determined contextual information to a database of shortcuts, wherein each shortcut comprises an associated contextual trigger; and
in response to identifying a match between the determined contextual information and a contextual trigger for a given shortcut in the database, presenting a suggestion associated with the given shortcut.

10. The method defined in claim 9, further comprising:
obtaining, via a second subset of the one or more sensors, a user input; and
in response to the user input, performing an action associated with the given shortcut, wherein performing the action associated with the given shortcut comprises presenting content or transmitting a command to an additional electronic device.

11. The method defined in claim 10, further comprising:
in response to the user input, setting an action associated with the given shortcut to be automatically performed in response to subsequent identifications of the determined contextual information.

12. The method defined in claim 9, further comprising:
obtaining, via a second subset of the one or more sensors, a user input;
in response to the user input, foregoing performing an action associated with the given shortcut; and
in response to the user input, setting the given shortcut to not be suggested during subsequent identifications of the determined contextual information.

13. The method defined in claim 9, wherein the database of shortcuts is stored in at least one external server and wherein comparing the determined contextual information to a database of shortcuts comprises transmitting the determined contextual information to the at least one external server.

14. The method defined in claim 9, wherein the database of shortcuts comprises shortcuts generated using additional electronic devices.

15. The method defined in claim 9, wherein the determined contextual information comprises an identity of a physical object in a physical environment of the electronic device, a location, or an activity.

16. The method defined in claim 9, wherein the first subset of the one or more sensors comprises a camera, an accelerometer, a depth sensor, a microphone, an ambient light sensor, a magnetometer, a heart rate monitor, a temperature sensor, a touch sensor, a moisture sensor, a gas sensor, a barometer, a gaze-tracking sensor, a button, a light-based proximity sensor, or a global positioning system (GPS) sensor.

17. A non-transitory computer-readable storage medium storing one or more programs configured to be executed by one or more processors of an electronic device that comprises one or more sensors, the one or more programs including instructions for:
obtaining, via a first subset of the one or more sensors, first sensor data, wherein the first sensor data comprises one or more images;
determining contextual information based on the first sensor data;
comparing the determined contextual information to a database of shortcuts, wherein each shortcut comprises an associated contextual trigger; and
in response to identifying a match between the determined contextual information and a contextual trigger for a given shortcut in the database, presenting a suggestion associated with the given shortcut.

18. The non-transitory computer-readable storage medium defined in claim 17, wherein the instructions further comprise instructions for:
obtaining, via a second subset of the one or more sensors, a user input; and
in response to the user input, performing an action associated with the given shortcut, wherein performing the action associated with the given shortcut comprises presenting content or transmitting a command to an additional electronic device.

19. The non-transitory computer-readable storage medium defined in claim 18, wherein the instructions further comprise instructions for:
in response to the user input, setting an action associated with the given shortcut to be automatically performed in response to subsequent identifications of the determined contextual information.

20. The non-transitory computer-readable storage medium defined in claim 17, wherein the instructions further comprise instructions for:
obtaining, via a second subset of the one or more sensors, a user input;
in response to the user input, foregoing performing an action associated with the given shortcut; and
in response to the user input, setting the given shortcut to not be suggested during subsequent identifications of the determined contextual information.

21. The non-transitory computer-readable storage medium defined in claim 17, wherein the database of shortcuts is stored in at least one external server and wherein comparing the determined contextual information to a database of shortcuts comprises transmitting the determined contextual information to the at least one external server.

22. The non-transitory computer-readable storage medium defined in claim 17, wherein the database of shortcuts comprises shortcuts generated using additional electronic devices.

23. The non-transitory computer-readable storage medium defined in claim 17, wherein the determined contextual information comprises an identity of a physical object in a physical environment of the electronic device, a location, or an activity.

24. The non-transitory computer-readable storage medium defined in claim 17, wherein the first subset of the one or more sensors comprises a camera, an accelerometer, a depth sensor, a microphone, an ambient light sensor, a magnetometer, a heart rate monitor, a temperature sensor, a touch sensor, a moisture sensor, a gas sensor, a barometer, a gaze-tracking sensor, a button, a light-based proximity sensor, or a global positioning system (GPS) sensor.
